(19) United States
(12) Patent Application Publication
(10) Pub. No.: US 2026/0069901 A1
(43) Pub. Date: Mar. 12, 2026

(54) NATURAL-MATERIAL INTERFACES FOR PREVENTING SYNTHETIC BODY CONTACT

(71) Applicant: Mote London, North Hollywood, CA (US)

(72) Inventor: Mote London, North Hollywood, CA (US)

(21) Appl. No.: 19/239,906

(22) Filed: Jun. 16, 2025

Related U.S. Application Data
(60) Provisional application No. 63/635,067, filed on Apr. 17, 2024.

(51) Int. Cl. A62B 99/00

(52) U.S. Cl. CPC A62B 99/00

(57) ABSTRACT

Natural-material interfaces are disclosed for articles that include synthetic surfaces which would otherwise come into contact with the body or be frequently handled. Each interface presents a body-contacting surface composed entirely of natural, non-synthetic materials, and is configured to shied or prevent direct contact between the user and underlying synthetic components.

Interfaces may take the form of removable, replacement, integrated, or other interface configurations adapted to components such as eyeglass pads, straps, cushions, phone grips, earbuds, steering wheels, or other body-contact surfaces. Materials may include hemp, wool, leather, cork, gold, or other substances derived from plant, animal, or mineral sources. Elements may include synthetic materials, provided they do not contact the body. The invention offers biocompatible, hypoallergenic, and health-safe alternatives for synthetic surfaces. Interfaces may be dimensioned for standard products and provided as kits or standalone units, reducing user exposure to synthetic compounds during use.

### BACKGROUND OF THE INVENTION

### Field of the Invention

The present invention relates generally to wearable and frequently handled articles that have body-contacting synthetic-material components, and more particularly to interfaces composed of natural, non-synthetic materials that cover, replace, or otherwise shield or prevent these synthetic components from directly contacting the body. The invention addresses rising concerns of health issues relating to physical contact with synthetic materials and the need for safer, biocompatible alternatives.

### Description of Related Art

Modern body-contacting and frequently touched articles—including eyeglasses, headphones, helmets, wristbands, and smart devices—commonly incorporate synthetic materials such as silicone, foam, thermoplastics, elastomers, and synthetic fabrics at the points of contact with the user's body. These materials are often chosen for their durability, low cost, and moldability. However, prolonged or repeated bodily contact with such synthetic substances has raised growing health concerns.

Existing art in this field includes cushioned fabric covers for eyewear or helmet pads, steering wheel wraps, and strap sleeves, many of which use elastic, polyester, synthetic blends, or adhesive-backed foams. While some patents disclose the use of natural materials such as cork or leather for cosmetic overlays, they often involve the use of synthetic adhesives and fillers in ways that still result in synthetic skin contact.

Moreover, existing solutions tend to focus on comfort, aesthetics, or hygiene (e.g., disposable liners), rather than addressing the core need for complete elimination of synthetic contact in a durable, reusable, and body-safe form.

Existing art fails to address a unified system of interfaces in which any physical configuration—whether removable, replacement-based, or integrated—ensures that only natural, non-synthetic materials are present at the body-contacting surface.

There is therefore a need in the art for an interface that may take the form of a single component or a group of components, and that includes, but is not limited to, covers and replacement components. Each such interface provides a body-contacting surface that is composed entirely of natural, non-synthetic materials. The invention preferably:
Can be applied across a wide range of body-contacting and frequently touched articles;
Supports flexible material and construction methods, provided that any synthetic adhesives, synthetic fasteners, or synthetic elastomeric components are positioned such that only natural, non-synthetic materials contact the user's body during normal use.
Provides a health-safe, biocompatible, and hypoallergenic alternative to conventional body-contacting components.

The present invention meets these needs by offering natural-material interface components, designed specifically to cover, replace, or otherwise shield or prevent synthetic body-contact points, thereby improving long-term user health and safety.

### SUMMARY OF THE INVENTION

The present invention relates to natural-material interfaces for articles with synthetic body-contacting or frequently touched surfaces. In all embodiments, the surface of the interface intended to contact the user's body is composed entirely of natural, non-synthetic materials, while other non-contacting portions of the interface may incorporate structural or fastening elements made from other substances.

The invention includes interfaces in a variety of configurations, including but not limited to removable and replacement or integrated components, each having a body-contacting surface composed entirely of natural, non-synthetic materials. It applies to body-contacting articles and frequently handled objects, providing a health-safe, biocompatible, hypoallergenic interface that reduces exposure to plastics, synthetic foams, synthetic adhesives, and other synthetic substances known to cause irritation or adverse health effects.

### BRIEF DESCRIPTION OF THE DRAWINGS

FIG. 1 shows two removable interface configurations (100), including cotton covers for eyeglass pads (1a), and a similar cover for an earbud (1b), each featuring a natural-material surface (102) and elastic rim (104).

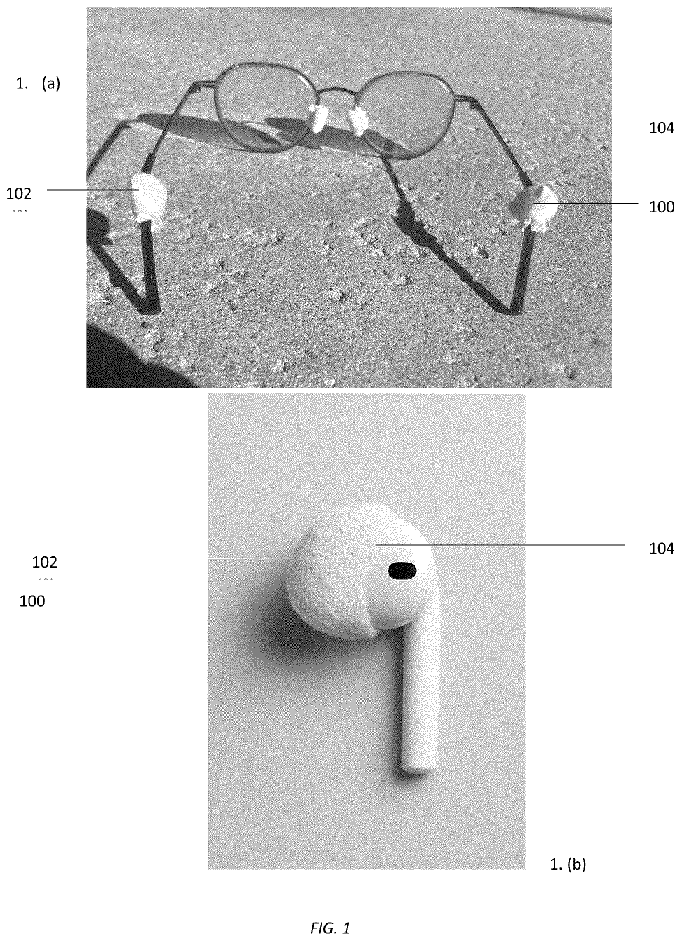

FIG. 2 shows a replacement configuration in which cork nose pads (112) are secured to an eyeglass frame (116) using a screw attachment (114), forming a natural-material interface (110).

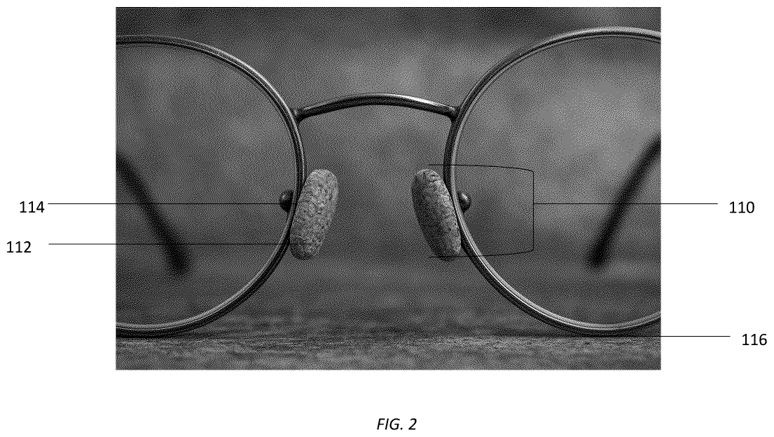

FIG. 3 shows an integrated interface configuration (120), in which a cork material (122) is built into the eyeglass frame structure (124) as an integrated cork pad (126).

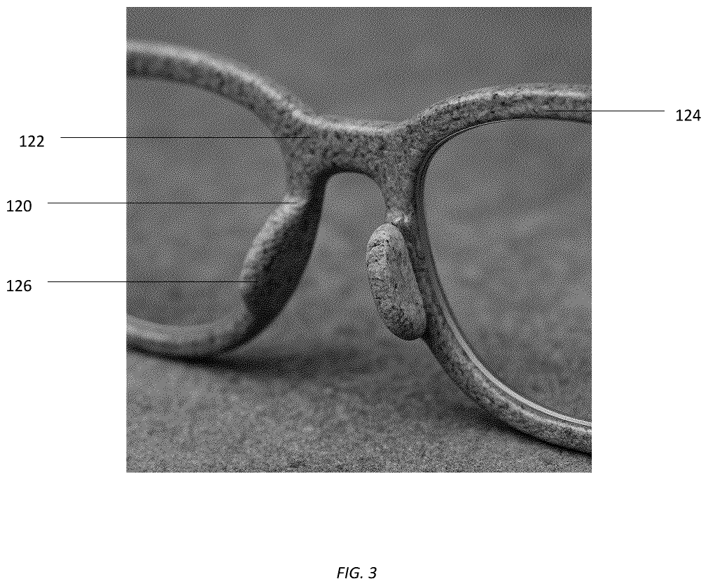

FIG. 4 shows a multipurpose interface (130), composed of a natural fabric (132) with an elastic band (134), dimensioned for use with multiple article types such as eyeglass nose pads or earbuds.

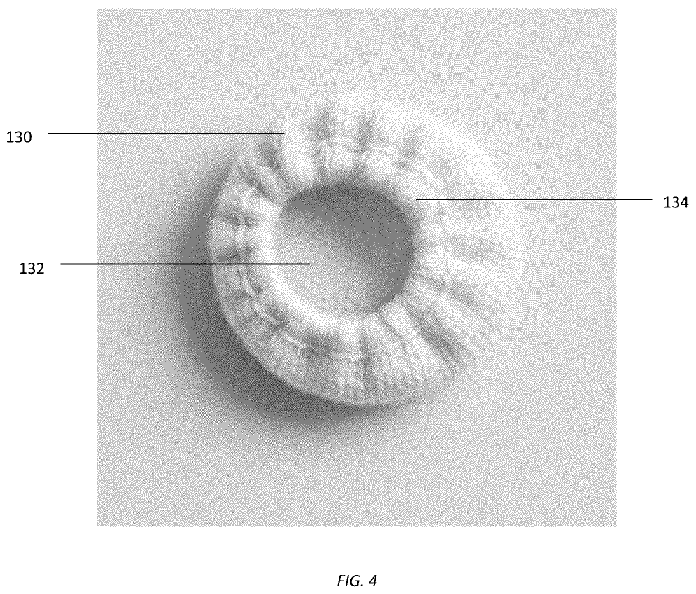

FIG. 5 shows a multi-surface interface system (140), including an ear cushion interface (142) and a headband pad interface (144), configured for use with multiple body-contacting surfaces of a single article.

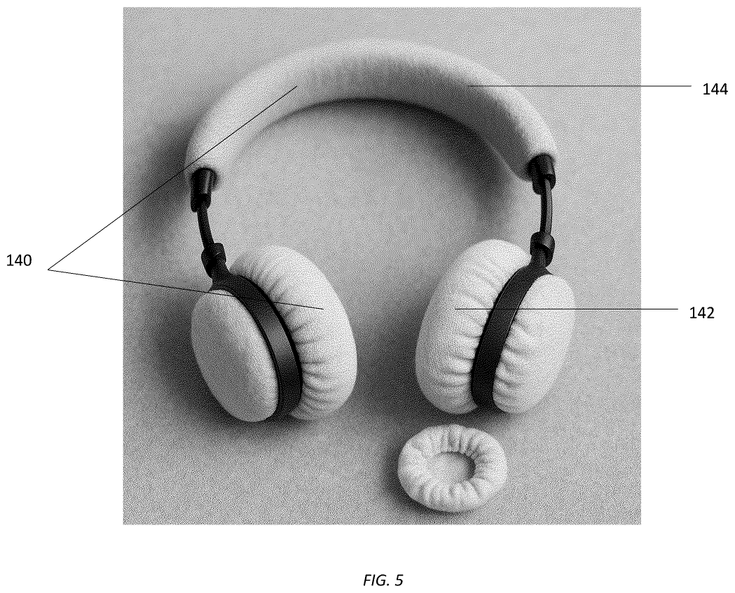

Note: Certain figures are presented as color photographs in order to accurately depict the natural materials, surface texture, and appearance of the interfaces. The use of color is necessary to convey distinguishing features that cannot be clearly shown in black-and-white line drawings, including the visual qualities of cork, cotton, or other natural substances.

### DETAILED DESCRIPTION OF THE INVENTION

The invention is directed to interfaces composed of natural, non-synthetic materials that are configured to prevent direct contact with synthetic materials at body-touching surfaces of body-contacting or frequently handled articles. These interfaces may take the form of removable, replacement, or integrated components, and may be implemented as single items or multi-part configurations. The goal is to prevent prolonged or repeated body contact with synthetic materials such as silicone, polyurethane foam, PVC, thermoplastic elastomers, synthetic adhesives, synthetic textiles, and other polymer-based substances that may cause irritation, allergic reactions, or cumulative toxic exposure over time.

### Materials

All interfaces described herein are made entirely of natural, non-synthetic materials at the surface intended to contact the user's body. For the purpose of this invention, the term “natural, non-synthetic materials” refers to substances derived from plant, animal, or mineral sources, without synthetic polymerization, chemical synthesis, or petroleum-based processing. Examples include, but are not limited to:
Plant-based materials: hemp, flax, cotton, cork, bamboo, jute, and plant-derived rubber;
Animal-based materials: wool, leather, rawhide, silk, horn, shell;
Mineral-based materials: untreated cork, stone, metallic elements such as silver or gold, and shell products.

These materials may be used singly or in combination, including layered or interlaced configurations, and may be incorporated into composite or multi-part structures, so long as the surface in contact with the user's body is composed exclusively of natural, non-synthetic substances.

### Removable Interface Configurations

In one embodiment, the invention comprises removable interfaces, which may include covers, sleeves, wraps, or other structures that are configured to fit over and shield existing synthetic components without requiring permanent attachment. These interfaces have a body-contacting surface composed entirely of natural, non-synthetic materials and are designed to be secured using any suitable temporary fastening method, such as friction fit, elastic tension (104), or tie-based mechanisms. Examples include:
Eyeglass nose pad sleeves (100, 102, 104);
Earphone or earbud sleeves (100, 102, 104);
Strap wraps for watches or headsets;
Helmet liner inserts;
Earphone or earbud sleeves;
Steering wheel interfaces;
Mobile phone grip or backing pads.

Synthetic adhesives, synthetic fasteners, or synthetic elastomeric elements may be used in portions of the interface that do not contact the user's body. Where fastening is required, natural threads, toggles, or concealed elastics (104) may optionally be used, provided that the portion in contact with the body remains entirely natural and non-synthetic (102).

### Replacement and Integrated Interface Configurations

In another embodiment, the invention comprises replacement-type or integrated interfaces, wherein the portion of the interface intended to contact the user's body is composed entirely of natural, non-synthetic materials. Replacement-type interfaces may be configured for user installation, while integrated interfaces may be incorporated during manufacture as permanent or semi-permanent components. These may include by way of non-limiting example:
A leather or cork nose pad for eyeglasses (112) attached via screw mechanism (114) into the eyeglass frame (116) to form a replacement interface (110);
A leather or silver strap to replace a plastic wristband;
A silk headset cushion instead of foam;
Silk, wool, or cotton cushions for earphones and headsets;
A natural-material phone grip or camera interface pad;
A cork or leather surface segment for a steering wheel;
A cork or gold surface for earbuds.

Each interface is designed to fulfill the functional role of the original while eliminating synthetic body contact. These interfaces may be sold individually or as part of a set.

In integrated embodiments, the interface may be manufactured directly as part of the article, such as:
An eyeglass frame (124) with integrated cork nose pads (126) made from cork material (122) to form an integrated interface (120).

### Modular and Multi-surface Interface Systems

The invention may be sold as a modular system or kit containing various interface types sized for commonly used articles. The system may be designed to support either or both of 1) a range of different article types, such as eyewear, headsets, and handheld articles; and/or 2) multiple-body contacting surfaces on a single article, such as the pads, straps, and interior linings of a helmet or headset. The system may be marketed toward users with allergies, autoimmune sensitivities, material safety concerns, or environmental preferences. The modularity also allows users to customize the interface components applied to different article types, while ensuring that all body-contacting surfaces—such as those touching the skin, scalp, or nails—are composed entirely of natural, non-synthetic materials. Other portions of the interfaces may include structural or fastening materials that are not natural, provided they do not contact the user during normal use.

In some implementations, the system may include:
A multipurpose interface (130) composed of natural fabric (132) and a stretchable elastic band (134), which may fit over both eyeglass nose pads and earbuds;
A multi-surface interface system (140) for a single article (such as a headset), composed of both an ear cushion interface (142) and a headband pad interface (144) designed to prevent or shield synthetic contact at multiple locations on one item.

The approach may be particularly useful for those seeking consistent natural-material contact across a variety of articles.

### Distinguishing Features

Unlike commercial solutions using synthetic foams, synthetically laminated textiles, or synthetic disposable overlays, the present invention is distinguished by its use of exclusively natural, non-synthetic materials at the body-contacting interface. The invention encompasses removable, replacement, integrated, or alternative interface solutions, and can be tailored to accommodate different surface geometries and attachment needs, while maintaining the core requirement of a natural-material body-contacting surface to address rising concerns of the dermatological and systemic effects of long-term exposure to plastics, synthetic foams, synthetic rubbers, synthetic adhesives, and related polymers.

It will be understood that the embodiments described above are merely illustrative and not limiting. Various modifications, adaptations, and equivalents may be made without departing from the scope and spirit of the invention. All combinations of the features described herein are intended to fall within the scope of the invention, and it is contemplated that the natural-material interfaces may be applied to a wide variety of products and body-contacting configurations beyond those specifically enumerated.

1. One or more interfaces for an article having one or more body-contacting or frequently handled synthetic-material surfaces, each interface comprising:
a body-contacting surface composed entirely of one or more natural, non-synthetic materials;
wherein the interface is configured to prevent or shield against direct contact between the synthetic-material surface of the article and the user during normal use.

2. The interface(s) of claim 1, wherein the natural, non-synthetic materials comprise one or more substances derived from plant, animal, or mineral sources, including but not limited to hemp, wool, leather, cork, gold, or plant-derived textiles.

3. The interface(s) of claim 1, wherein each interface includes one or more structural or fastening elements that are not composed of natural, non-synthetic materials, provided that such elements do not contact the user during normal use.

4. The interface(s) of claim 1, wherein each interface is configured to be removably secured over one or more synthetic components.

5. The interface(s) of claim 1, wherein each interface is configured to replace one or more synthetic body-contacting component of the article.

6. The interface(s) of claim 1, wherein each interface is integrated into the article as built-in or permanent body-contacting elements composed of natural, non-synthetic materials.

7. The interface(s) of claim 1, wherein each interface is configured for use with one or more of the following: eyeglass nose pads, headsets, ear cushions, helmet liners, wearable straps, earbuds, phone grips, steering wheels, watches, or other body-contacting or frequently touched articles.

8. The interface(s) of claim 1, wherein the interface is dimensioned for compatibility with multiple article types or is provided as part of a modular or interchangeable system.

9. The interface(s) of claim 1, wherein the interface if configured to cover substantially all synthetic-material surfaces of the article that would otherwise contact the user's body during normal use.

10. A system comprising one or more interfaces according to claim 1, each interface configured for use with one or more synthetic body-contacting or frequently handled surfaces, including multiple surfaces of a single article or multiple different articles;
wherein each interface comprises a body-contacting surface composed entirely of one or more natural, non-synthetic materials;
and wherein the system is configured to reduce user exposure to synthetic materials during normal use.

11. The system of claim 10, wherein the interfaces are provided as a kit of interchangeable components for multiple articles or multiple body-contacting surfaces of a single article.

12. The system of claim 10, wherein each interface is removably attachable using mechanical or friction-fit means, enabling user customization across different articles or multiple contact surfaces of a single article.
